(19) United States
(12) Patent Application Publication
(10) Pub. No.: US 2022/0032464 A1
(43) Pub. Date: Feb. 3, 2022

(54) MOTION MONITORING OF A ROBOT MANIPULATOR

(71) Applicant: FRANKA EMIKA GMBH, München (DE)

(72) Inventors: Andreas Spenninger, Karlsfeld (DE); Saskia Golz, München (DE); Dmitrij Forssilow, München (DE); Sven Parusel, München (DE)

(21) Appl. No.: 17/413,819

(22) PCT Filed: Dec. 19, 2019
(86) PCT No.: PCT/EP2019/086259

§ 371 Date: Jun. 14, 2021

(30) Foreign Application Priority Data
Dec. 21, 2018 (DE) 10 2018 133 472.9

(51) Int. Cl. B25J 9/16

(52) U.S. Cl. CPC B25J 9/1676

(57) ABSTRACT

A device and method for monitoring a motion of a robot manipulator, including operations of:
defining a forbidden position for the robot manipulator,
defining a curve running along the robot manipulator with a one-dimensional running coordinate s, wherein at least a subset of all locations of the curve is moved together with a current pose of the robot manipulator, and
determining a distance d between a location of a current curve and/or a predicted curve and the forbidden position.

### CROSS-REFERENCE TO RELATED APPLICATIONS

The present application is the U.S. National Phase of PCT/EP2019/086259, filed on Dec. 19, 2019, which claims priority to German Patent Application No. 10 2018 133 472.9, filed on Dec. 21, 2018, the entire contents of which are incorporated herein by reference.

### BACKGROUND

### Field

The invention relates to a method for monitoring a motion of a robot manipulator, and to a device for monitoring a motion of a robot manipulator.

### Related Art

It is known from the prior art to move finite volumes, defined via geometric shapes, together with associated robot links, and to model a spatial extent of each of the robot links by means of these volumes. For example, EP1901151A1 relates to a method for avoiding collisions between an industrial robot and at least one other moving object.

### SUMMARY

The object of the invention is to simplify motion monitoring of a robot manipulator with regard to forbidden positions or areas, and to make this motion monitoring more computationally efficient. In the context of self-collisions which must be avoided, the forbidden position can also be assigned to the robot manipulator itself.

The invention results from the features of the independent claims. Advantageous refinements and embodiments are the subject of the dependent claims.

A first aspect of the invention relates to a method of monitoring a motion of a robot manipulator, the method including:
defining a forbidden position for the robot manipulator,
defining a curve running along the robot manipulator and having a one-dimensional running coordinate s, wherein at least a subset of all locations of the curve are moved together with a current pose of the robot manipulator, and
determining a distance d between a location of a current curve and/or a predicted curve and the forbidden position.

The robot manipulator is in particular a multi-joint robot arm with an end effector arranged at its distal end. The links of the robot arm are preferably movable relative to each other by means of articulated joints and/or rotary joints. Actuators, in particular electric motors which can be connected to a gearing, generate corresponding forces and moments for moving the links relative to each other about each joint.

The forbidden position for the robot manipulator is a position which, in particular, a robot link or an end effector arranged at the distal end of the robot manipulator should ultimately not reach. Advantageously, however, the motion monitoring according to the first aspect of the invention is not necessarily limited to the actual dimensions of the robot manipulator and/or the end effector, since determining the distance d results in all degrees of freedom with regard to the reaction to the determined distance d, as shown in the following embodiments. According to the first aspect of the invention, there is advantageously no dependency on a fixed geometric shape of a modeled volume.

In the present case, the term “pose” is understood in accordance with DIN EN ISO 8373. The pose of the robot manipulator is thus the combination of local position and local orientation of the robot manipulator in three-dimensional space.

The running coordinate is one-dimensional because only one coordinate s has to be specified, with its sign, in order to clearly indicate a location on the curve. In contrast, the curve itself generally runs through the three-dimensional space, in particular through the working area of the robot manipulator, according to the current pose of the robot manipulator.

The course of the curve running along the robot manipulator with the one-dimensional running coordinate s through physical space is basically determined by the current pose of the robot manipulator. The curve preferably runs at least in sections through a geometric center of each of the sections of the robot manipulator—that is to say, also of each robot link. Deviations from the geometric center can result if the radii of curvature of the curve are limited. Advantageously, a polynomial curve of a lower order is easier to handle analytically and also numerically than a polynomial curve of a higher order. In the case of curves of a lower order, on the other hand, the freedom to design the course of the curve and thus the variability of its radii of curvature over its running coordinates s is more limited, such that the course of the robot manipulator in its current pose can be followed less precisely.

The radius r(s) is preferably constant over the one-dimensional running coordinate s.

The distance d is preferably determined by discretizing the curve—that is, a finite set of locations on the analytically defined curve is considered. Then, in particular, a set of distances between the locations is determined from the finite set of locations of the current and/or predicted curve and the forbidden position. The shortest of all distances is preferably determined from the set of distances determined in this way. According to a further advantageous embodiment, instead of selecting the shortest of all distances, at least one further iteration step takes place, in which the two locations on the curve with the two shortest distances are selected, and a third location between the two locations on the curve with the two shortest distances is selected, and then the distance d between this third location and the forbidden position is determined. From the distances between the two locations on the curve with the two shortest distances and the third location, the location with the shortest distance is then specifically selected and defined as the only distance d to be determined. The choice of the third location and further locations on the curve in further iteration steps is determined in particular using the golden section search method or other methods such as are known from line search methods used, for example, in non-linear optimization methods.

The method preferably also includes:
initiating a safety reaction of the robot manipulator when the distance d falls below a prespecified threshold value. The safety reaction can be: Issuing a warning signal, moving the robot manipulator into a safe pose, halting the robot manipulator, interrupting a power supply for the drives of the robot manipulator, changing the planned path of the robot manipulator, or the like.

It is an advantageous effect of the invention that the numerically complex modeling of artificial volumes virtually arranged on the robot links, for modeling the dimensions of each of the robot links, is dispensed with. Instead, a curve is used that is mathematically very easily defined, each location on the curve being defined using a single coordinate.

According to an advantageous embodiment, the method furthermore includes:
defining a radius r(s) around the curve, the radius r(s) specifying a safety distance to be maintained between the curve and the forbidden position, and
verifying whether the distance d between the location of the current and/or predicted curve and the forbidden position is less than a radius r(s).

The expression r(s) defines a finite or an infinite set of points, depending on which density of values of r(s) is defined via the coordinate s, which in principle runs continuously. If an analytical function is used for r(s), apart from discretizations and quantizations, as occur in all calculating machines, an r(s) is defined for each location on the continuous curve having the coordinate s. In the simplest case, r(s)=c is defined, which means that the radius r(s) has a single, always constant value c over all locations on the curve. Another possibility for a simple analytical function of the radius r(s) from the coordinate s would be r(s)=k*s+r₀, where r₀ is a predefined starting value and k*s is a linear change component of r(s) over the running coordinate s. Further linear or non-linear relationships are possible.

According to a further advantageous embodiment, the curve is defined by interpolating from a finite number of prespecified locations on the robot manipulator, as supporting points.

From the information for each supporting point position, an interpolation algorithm generates locations on the curve for positions between the supporting points. A polynomial interpolation is preferably used. In this case, the algorithm searches for a corresponding polynomial that runs through the supporting points. The supporting points are preferably determined by means of position sensors, in particular position sensors which are arranged on the joints and/or actuators of the robot manipulator. The known geometry of intrinsically immobile parts, such as rigid robot links, can be used as information in determining the position of the supporting points.

According to a further advantageous embodiment, the curve is defined as a Bézier curve, based on a finite number of prespecified locations on the robot manipulator as supporting points.

A Bézier curve is particularly easy to use mathematically. At a minimum, a first location on the curve is defined as the starting point, and a second location on the curve is defined as the end point of the Bézier curve. Further locations of the curve can be defined as supporting points, although increasing numbers of supporting points worsen the mathematical manageability of the Bézier curve, and increase the complexity and thus the computational effort.

According to a further advantageous embodiment, a tangent of a cubic Bézier curve is determined from each of the orientations of the robot manipulator at each of the prespecified locations. The measure of the length for each tangent is preferably defined according to a length of the given robot link—that is to say, generalized according to the length of a rigid body section of the robot manipulator located at the given location of the curve at which the tangent is defined. The longer the rigid body section of the robot manipulator, the longer the tangent in the supporting point and therefore the lower the rate of change of a radius of curvature for the one-dimensional running coordinate s in the region of this location.

In contrast to a quadratic Bézier curve, a cubic Bézier curve has two independent degrees of freedom for tangent formation, one each at a starting point and an end point of the Bézier curve. However, a higher-order Bézier curve is advantageously used in order to define more locations than merely the starting point and an end point of the Bézier curve over the pose of the robot manipulator. For this purpose, further supporting points are advantageously defined, and the curve is preferably composed of several portions, each portion constituting a cubic Bézier curve. The orientation of the robot manipulator, which is used at certain points of the curve for the tangent definition of a complete or partially defined Bézier curve, is described in particular by a set of orientation angles—in particular, a complete set—of the portion in question of the robot manipulator, with respect to a fixed coordinate system.

According to a further advantageous embodiment, the curve is composed of a finite number of straight sections. The points of intersection between at least some of the finite number of sections are advantageously located on a kinematic axis of each of the articulated joints. Furthermore, at least some of the finite number of sections advantageously run, at least in sections, along axes of rotation of the given rotary joint. In contrast to an articulated joint, which allows two links to be tilted relative to each other, a rotary joint allows two links to be rotated relative to each other about a longitudinal axis of at least one link.

According to a further advantageous embodiment, a tangent of a polynomial curve or a Bézier curve is congruent with an axis of rotation of a rotary joint between two links of the robot manipulator; alternatively, a tangent of a polynomial curve or a Bézier curve is congruent with an axis of rotation of a rotary joint between two links of the robot manipulator.

According to a further advantageous embodiment, the radius r(s) varies over the one-dimensional running coordinate s based on at least one of the following dependencies:
Dependence on a time: r(s,t),
Dependence on the local diameter of the robot manipulator: r(s),
Dependence on an opening state of a gripper on a distal end of the robot manipulator: r(s),
Dependence on a current effective velocity: r(v(s)),
Dependence on an operating mode and/or an environment of the robot manipulator;

The dependence on the current effective velocity—that is to say, r(v(s))—is used particularly advantageously to take into account a greater deceleration distance at higher speeds of the robot manipulator.

According to a further advantageous embodiment, the forbidden position is arranged at a location on the robot manipulator, and is moved together with a motion of the robot manipulator.

According to this embodiment, a self-collision of the robot manipulator can advantageously be prevented. In particular, the forbidden position is on the curve itself.

According to a further advantageous embodiment, the curve runs through at least one axis of rotation of an articulated joint of the robot manipulator. This means that the curve intersects the—particularly kinematic—axis of rotation of the given articulated joint at one point. The curve advantageously intersects the axis of rotation at a right angle at the point of intersection.

According to a further advantageous embodiment, the distance d is a shortest distance between the current and/or predicted curve and the forbidden position.

Another aspect of the invention relates to a device for monitoring a motion of a robot manipulator. The device has a computing unit that is designed to define a forbidden position for the robot manipulator, to define a curve running along the robot manipulator with a one-dimensional running coordinate s, wherein at least a subset of all locations of the curve is moved together with a current pose of the robot manipulator, and to determine a distance d between a location of a current curve and/or a predicted curve and the forbidden position.

Advantages and preferred developments of the proposed device result from an analogous and corresponding application of the statements made above in connection with the proposed method.

Further advantages, features and details result from the following description, in which—if necessary with reference to the drawings—at least one example embodiment is described in detail. Identical, similar, and/or functionally identical parts are provided with the same reference numerals.

### BRIEF DESCRIPTION OF THE DRAWINGS

In the drawings:

FIG. 1 is a device for monitoring a motion of a robot manipulator according to an embodiment of the invention, and

FIG. 2 is a method for monitoring a motion of a robot manipulator according to a further embodiment of the invention.

### DETAILED DESCRIPTION

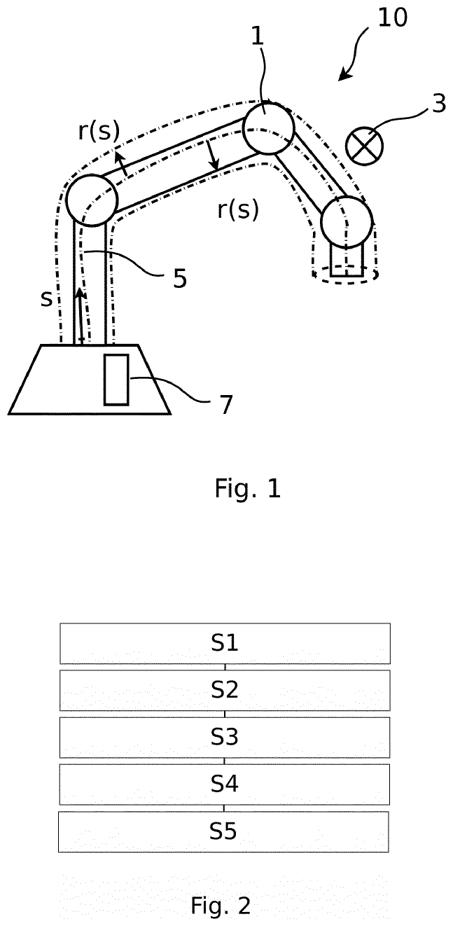

The illustrations in the drawings are schematic and not to scale. FIG. 1 and FIG. 2 complement each other here. In particular in the description of FIG. 2, FIG. 1 can therefore also be used for a better understanding.

FIG. 1 shows a device 10 for monitoring a motion of a robot manipulator 1, including a computing unit 7 which is designed to define a forbidden position 3 for the robot manipulator 1, to define a curve 5 running along the robot manipulator 1 with a one-dimensional running coordinate s, wherein at least a subset of all locations of the curve 5 is moved together with a current pose of the robot manipulator 1, and to determine a distance d between a location of a current curve and/or a predicted curve 5 and the forbidden position 3, the distance d being the shortest distance between the current curve and/or predicted curve 5 and the forbidden position 3. The curve 5 is defined here as a Bézier curve based on a finite number of prespecified locations on the robot manipulator 1 as supporting points. FIG. 1 shows a cubic Bézier curve as a curve 5 with five supporting points, each of which lies on the axis of rotation of a joint between two links of the robot manipulator 1, and also at a base point and at a point on the end effector of the robot manipulator. The corresponding tangents of the Bézier curve are also defined for each of these supporting points. The radius r(s) is defined for the one-dimensional running coordinate s based on the dependence on a current effective velocity: r(v(s)).

FIG. 2 shows a method of monitoring a motion of a robot manipulator 1, wherein the method includes:
defining S1 a forbidden position 3 for the robot manipulator 1,
defining S2 a curve 5 running along the robot manipulator 1 with a one-dimensional running coordinate s, wherein at least a subset of all locations of the curve 5 are moved together with a current pose of the robot manipulator 1, and
determining S3 a distance d between a location of a current curve and/or a predicted curve 5 and the forbidden position 3,
defining S4 a radius r(s) around the curve 5, the radius r(s) specifying a safety distance to be maintained between the curve 5 and the forbidden position 3, and
verifying S5 whether a distance d between a location of the current curve and/or the predicted curve 5 and the forbidden position 3 is less than the radius r(s).

Although the invention has been illustrated and explained in greater detail by means of preferred embodiments, the invention is not limited by the disclosed examples and other variations may be derived therefrom by a person skilled in the art without departing from the scope of protection of the invention. It is therefore clear that there are a plurality of possible variations. It is also clear that embodiments cited by way of example actually only constitute examples that are not to be interpreted in any way as a limitation of the scope, of the potential applications, or of the configuration of the invention. Rather, the preceding description and the description of the figures enable the person skilled in the art to specifically implement the embodiments, wherein the person skilled in the art, having knowledge of the disclosed inventive concept, is able to make numerous modifications—for example, with respect to the function or the arrangement of individual elements cited in an embodiment—without departing from the scope of protection, which is defined by the claims and their legal equivalents, such as a further explanation in the description.

### LIST OF REFERENCE NUMERALS

1 Robot manipulator

3 Forbidden position

5 Curve

7 Computing unit

10 Device

S1 Defining

S2 Defining

S3 Determining

S4 Defining

S5 Verifying

1. A method of monitoring a motion of a robot manipulator, the method comprising:
defining a forbidden position for the robot manipulator;
defining a curve running along the robot manipulator with a one-dimensional running coordinate s, wherein at least a subset of all locations of the curve is moved together with a current pose of the robot manipulator; and
determining a distance d between a location of a current curve and/or a predicted curve and the forbidden position.

2. The method according to claim 1, further comprising:
defining a radius r(s) around the curve, the radius r(s) indicating a safety distance to be maintained between the curve and the forbidden position; and
verifying whether the distance d between the location of the current curve and/or the predicted curve and the forbidden position is less than the radius r(s).

3. The method according to claim 1, wherein the curve is defined by interpolation based on a finite number of prespecified locations on the robot manipulator as supporting points.

4. The method according to claim 1, wherein the curve is defined as a Bézier curve based on a finite number of prespecified locations on the robot manipulator as supporting points.

5. The method according to claim 4, wherein a tangent of a cubic Bézier curve is determined from each orientation of the robot manipulator at each of the prespecified locations.

6. The method according to claim 2, wherein the radius r(s) varies over the one-dimensional running coordinate s based on at least one of the following dependencies:
dependence on a time: r(s,t);
dependence on the local diameter of the robot manipulator: r(s);
dependence on an opening state of a gripper at a distal end of the robot manipulator: r(s);
dependence on a current effective velocity: r(v(s)); and
dependence on an operating mode and/or an environment of the robot manipulator.

7. The method according to claim 1, wherein the forbidden position is arranged at a location on the robot manipulator and is moved together with a motion of the robot manipulator.

8. The method according to claim 1, wherein the curve runs through an axis of rotation of an articulated joint of the robot manipulator.

9. The method according to claim 1, wherein the distance d is a shortest distance between the current curve and/or the predicted curve and the forbidden position.

10. A device to monitor a motion of a robot manipulator, the device comprising a computing unit configured to:
define a forbidden position for the robot manipulator;
define a curve running along the robot manipulator with a one-dimensional running coordinate s, wherein at least a subset of all locations of the curve is moved together with a current pose of the robot manipulator; and
determine a distance d between a location of a current curve and/or a predicted curve and the forbidden position.

11. The device according to claim 10, wherein the computing unit is further configured to:
define a radius r(s) around the curve, the radius r(s) indicating a safety distance to be maintained between the curve and the forbidden position; and
verify whether the distance d between the location of the current curve and/or the predicted curve and the forbidden position is less than the radius r(s).

12. The device according to claim 10, wherein the curve is defined by interpolation based on a finite number of prespecified locations on the robot manipulator as supporting points.

13. The device according to claim 10, wherein the curve is defined as a Bézier curve based on a finite number of prespecified locations on the robot manipulator as supporting points.

14. The device according to claim 13, wherein a tangent of a cubic Bézier curve is determined from each orientation of the robot manipulator at each of the prespecified locations.

15. The device according to claim 11, wherein the radius r(s) varies over the one-dimensional running coordinate s based on at least one of the following dependencies:
dependence on a time: r(s,t);
dependence on the local diameter of the robot manipulator: r(s);
dependence on an opening state of a gripper at a distal end of the robot manipulator: r(s);
dependence on a current effective velocity: r(v(s)); and
dependence on an operating mode and/or an environment of the robot manipulator.

16. The device according to claim 10, wherein the forbidden position is arranged at a location on the robot manipulator and is moved together with a motion of the robot manipulator.

17. The device according to claim 10, wherein the curve runs through an axis of rotation of an articulated joint of the robot manipulator.

18. The device according to claim 10, wherein the distance d is a shortest distance between the current curve and/or the predicted curve and the forbidden position.
